(19) United States
(12) Patent Application Publication
(10) Pub. No.: US 2002/0123869 A1
(43) Pub. Date: Sep. 5, 2002

(54) Simulation method and test arrangement for determining nonlinear signal distortion

(75) Inventors: Heinz Koppl, Graz (AT); Gerhard Paoli, Villach (AT)

Correspondence Address: WITHROW & TERRANOVA, P.L.L.C., P.O. BOX 1287, CARY, NC, 27512, US

(73) Assignee: Infineon Technologies AG, Munich (DE)

(21) Appl. No.: 10/017,506

(22) Filed: Dec. 14, 2001

(30) Foreign Application Priority Data
Dec. 15, 2000 (DE) 100 62 571.1

(51) Int. Cl. G06G 7/48

(52) U.S. Cl. 703/4

(57) ABSTRACT

Simulation method for determining nonlinear signal distortion in an analog circuit (7), which is to be tested, for processing discrete multitone signals, with the simulation method having the following steps:

(a) application of a discrete multitone signal, which has a large number of uniformly spaced carrier frequencies for data transmission in a predetermined frequency range, to the analog circuit (7), which is to be tested, and to an adjustable modeling filter (18);

(b) subtraction of the output signal from the analog circuit (7), which is to be tested, from the output signal from the modeling filter (18) in order to produce a difference signal,

(c) adjustment of the modeling filter (18) until the difference signal is a minimum, in order to generate an equivalent test circuit of the analog circuit (7);

(d) reapplication of the discrete multitone signal, with at least one carrier frequency being suppressed, for measuring the intermodulation product (D) of the adjusted digital modeling filter (18).

The invention relates to a simulation method and a test arrangement for determining nonlinear signal distortion in an analog circuit, which is to be tested, for the processing of discrete multitone signals.

Signal distortion comprises undesirable changes to the signal form or signal curves when passing through transmission elements, for example amplifiers. A distinction is in this case drawn between linear and nonlinear signal distortion. Linear signal distortion is caused by frequency-dependent attenuation and phase shifts, and can be compensated for by means of suitable equalizers. In contrast to this, nonlinear signal distortion is caused by nonlinear characteristics of active components, and leads to the occurrence of signal harmonics of the frequencies contained in the signal. Nonlinear signal distortion distorts, for example, the comprehensibility and the tonal properties of tone signal transmissions.

One measure of nonlinear signal distortion that occurs within modulation limits is what is referred to as the distortion factor. The distortion factor is generally specified as the distortion level, as a percentage. A distinction is in this case drawn between the individual distortion factor for the individual harmonics, and the overall distortion factor, which is the ratio of the root mean square value of the harmonic voltage and the root mean square value of the overall voltage mixture.

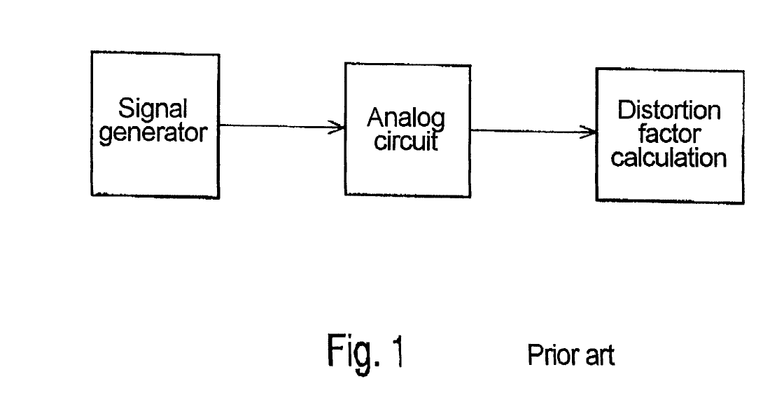

FIG. 1 shows, schematically, a measurement arrangement for measuring the nonlinearities in an analog circuit according to the prior art. The analog circuit to be measured contains a test signal from a signal generator, for example a sinusoidal test signal, and a downstream measurement circuit measures the output signal emitted from the analog circuit, and uses this to calculate the associated distortion factor.

The distortion factor or the THD value is a measure of the quality of the analog circuit, and its linearity.

The THD value or distortion factor provides only a very inaccurate measure of the linearity of such analog circuits, however, which are used for signal processing of discrete-modulated tone signals. The discrete multitone method or DMT method is a digital transmission method which is used in particular for short distances and for signals transmitted using wires. The DMT modulation method is used, for example, in xDSL transmission systems (DSL: Digital Subscriber Line), in which data transmission takes place bidirectionally via a twisted telephone line pair.

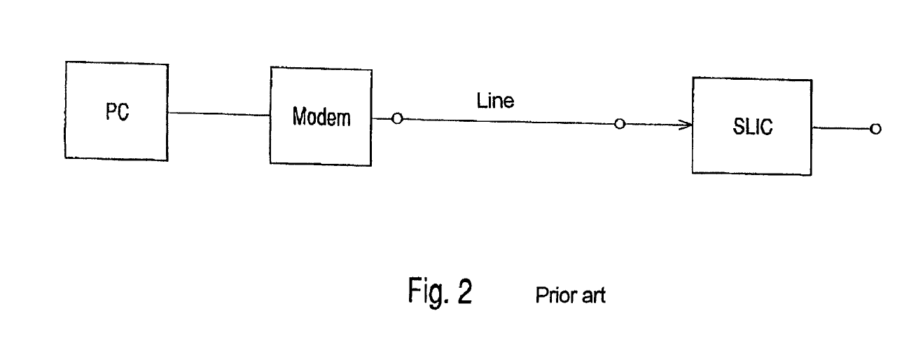

FIG. 2 shows, schematically, an arrangement in which an SLIC circuit (SLIC: Subscriber Line Interface Circuit) is connected via a telephone line to an end subscriber's modem, to which a computer is connected. Data is transmitted via the telephone line using the DMT method, in order to achieve high data transmission rates. In the DMT method, the available frequency band from 20 kHz to 1.104 MHz is subdivided into 255 subchannels, which each have a frequency bandwidth of 4.3125 kHz. For each of these subchannels, data is transmitted using a digital modulation method, for example a 64 QAM modulation method.

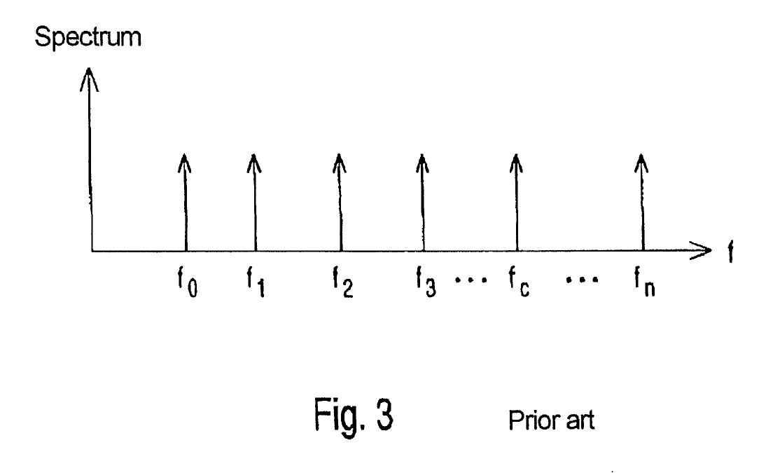

FIG. 3 shows, schematically, the signal spectrum of a DMT-modulated signal. If one wishes to investigate the effects of nonlinear signal distortion in the SLIC circuit on the transmission characteristics, measurement of the distortion factor of the SLIC circuit is not a suitable measure, since the DMT signal results in the production of intermodulation signal products with the spectrum illustrated in FIG. 3, and these corrupt the calculated distortion factor of the SLIC circuit.

The object of the present invention is thus to provide a method and a test arrangement using which the nonlinear signal distortion in an analog circuit for processing discrete multitone signals can be determined accurately.

According to the invention, this object is achieved by a simulation method having the features specified in patent claim 1, and by a test arrangement having the features specified in patent claim 8.

The invention provides a simulation method for determining nonlinear signal distortion in an analog circuit, which is to be tested, for processing discrete multitone signals, with the simulation method having the following steps, namely:

application of a discrete multitone signal, which has a large number of uniformly spaced carrier frequencies for data transmission in a predetermined frequency range, to the analog circuit, which is to be tested, and an adjustable modeling filter connected in parallel with it,

subtraction of the output signal from the analog circuit, which is to be tested, from the output signal from the modeling filter in order to produce a difference signal,

adjustment of the modeling filter until the difference signal is a minimum, in order to generate an equivalent test circuit of the analog circuit,

renewed application of the discrete multitone signal to the adjusted modeling filter, with at least one carrier frequency of the discrete multitone signal being suppressed, for measuring the intermodulation product of the adjusted digital modeling filter.

A multitone signal ratio is preferably calculated from the measured intermodulation product, as a measure of the nonlinear signal distortion.

The adjustable modeling filter is preferably a discrete Volterra filter.

In one preferred embodiment of the method according to the invention, the adjusted modeling filter which forms an equivalent circuit of the analog circuit is connected to further adjusted modeling filters, which form equivalent circuits of further analog circuits, in order to generate an overall equivalent circuit for an analog overall circuit.

The analog overall circuit is in this case preferably a DSL-SLIC circuit.

The discrete multitone signal is preferably generated by a signal generator.

The invention furthermore provides a test arrangement for determining nonlinear signal distortion of analog circuit elements of a signal processing circuit for signal processing of discretely modulated tone signals having:

a signal generator for producing a discrete multitone signal;

adjustable modeling filters which are each connected in parallel with an associated analog circuit element, with the signal inputs of the modeling filters and of the analog circuit elements being connected to the signal generator,

subtraction circuits, which each subtract the output signal from a modeling filter from the output signal from the associated analog circuit element in order to form a difference signal,

adjustment circuits, which compare each of the the difference signals with a nominal value and adjust the modeling filters until the difference signals match the respective nominal value,

and having a measurement circuit, which is connected to the outputs of the modeling filters, for measuring the intermodulation products of the modeling filters.

Preferred embodiments of the method according to the invention and of the test arrangement according to the invention will be described in the following text in order to explain features that are essential to the invention.

In the figures:

FIG. 1 shows a measurement arrangement for determining nonlinear signal distortion in an analog circuit, which is to be tested, according to the prior art;

FIG. 2 shows an xDSL circuit arrangement according to the prior art,

FIG. 3 shows a signal spectrum of a DMT signal according to the prior art;

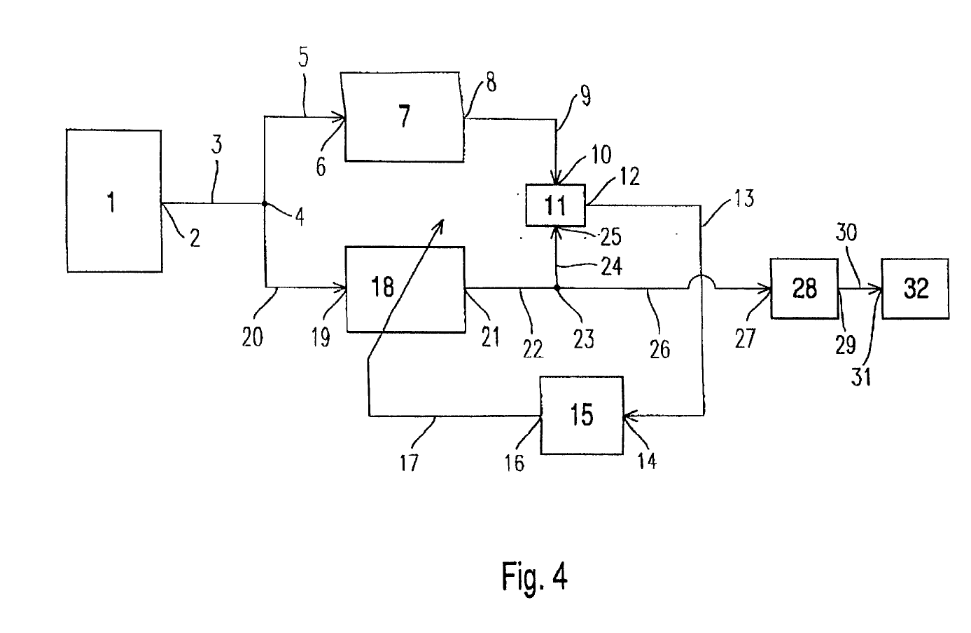

FIG. 4 shows a test arrangement for determining nonlinear signal distortion according to the invention;

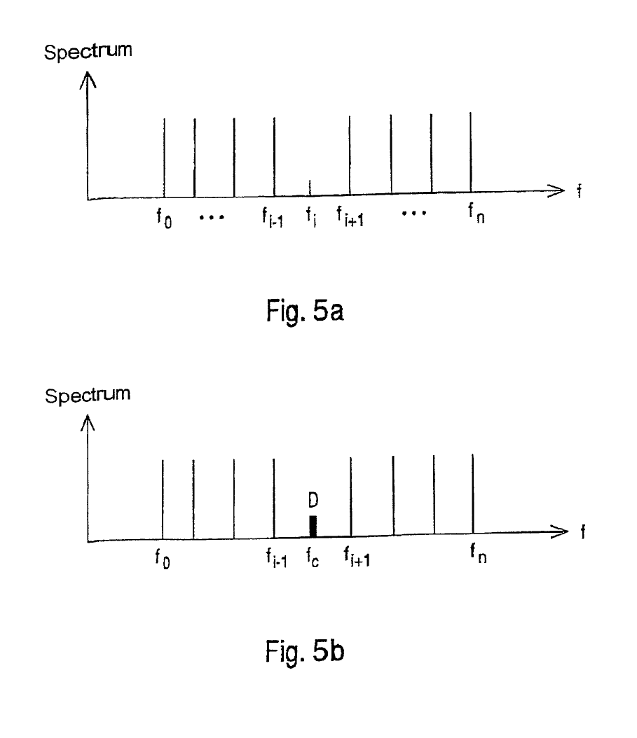

FIG. 5 shows a signal spectrum of DMT signals;

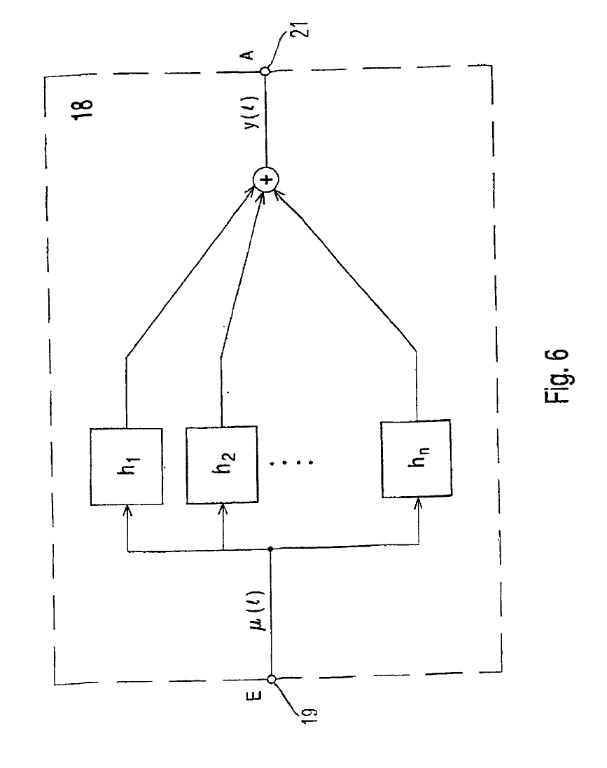

FIG. 6 shows a block diagram of an adjustable modeling filter according to the invention;

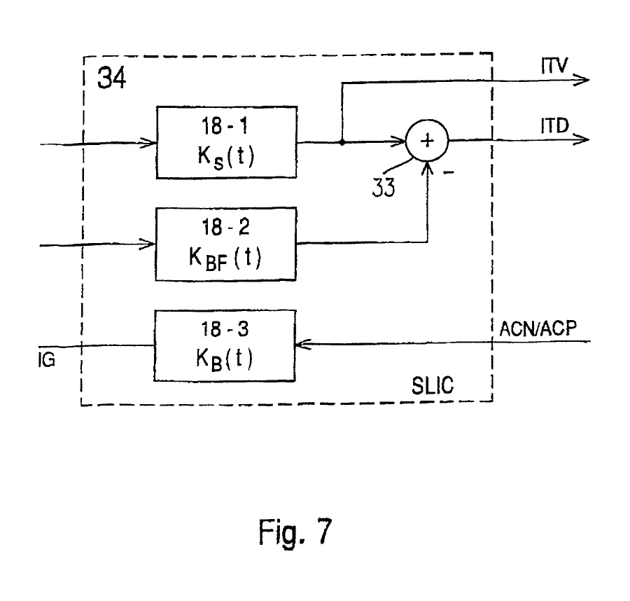

FIG. 7 shows an example of an overall equivalent circuit for an SLIC circuit, which has been generated in accordance with the method according to the invention.

FIG. 4 shows, schematically, a test arrangement according to the invention for determining nonlinear signal distortion in an analog circuit.

A signal generator 1 having a signal output 2 is connected to a branch node 4 via a line 3. The branch node 4 is connected via a line 5 to a signal input 6 of an analog circuit 7, which is to be tested and has a signal output 8. The signal output 8 of the analog circuit 7 is connected via a line 9 to an input 10 of a subtraction circuit 11. The subtraction circuit 11 has an output 12, which is connected via a line 13 to an input 14 of a filter adjustment circuit 15. The adjustment circuit 15 has an output 16, which is connected via adjustment lines 17 to an adjustable modeling filter 18. The modeling filter 18 has a signal input 19, which is connected via a signal line 20 to the branch node 4. The adjustable modeling filter 18 furthermore has a signal output 21, which is connected via a line 22 to a branch node 23. The branch node 23 is connected via a line 24 to a second input 25 of the subtraction circuit 11. The branch node 23 is furthermore connected via a line 26 to an input 27 of a measurement circuit 28. The measurement circuit 28 is intended for measuring an intermodulation product of the adjusted digital modeling filter 18. The measurement circuit 28 has a signal output 29, which is connected via a line 30 to an input 31 of a calculation circuit 32 for calculating a multitone signal power ratio MTPR.

The analog test circuit 7, as is illustrated in FIG. 4, may be any desired analog circuit, for example a circuit element within an analog SLIC circuit. Analog circuit elements such as these include, for example, a current sensor provided in the SLIC circuit, an echo signal compensation circuit or a buffer operational amplifier. A discrete multitone signal is applied in parallel as a simulation signal to the two signal inputs 6, 19 of the analog circuit 7, which is to be tested, and of the modeling filter 18. The analog circuit 7, which is to be tested, emits an output signal via the signal output 8 to the signal input 10 of the subtraction circuit 11, which subtracts the output signal emitted from the modeling filter 18 from this output signal, and emits a difference signal via the signal output 12 and the signal line 13 to the signal input 14 of the adjustment circuit 15. The adjustment circuit 15 compares the applied difference signal with a nominal value, for example zero. The adjustment circuit 15 adjusts the parameters or filter coefficients of the modeling filter 18 until the applied difference signal reaches the nominal value. The adjustment process is then ended, and the adjusted modeling filter 18 forms an equivalent circuit for the analog circuit 7 which is to be tested. In a further step, the signal generator 1 produces a further discrete multitone signal, which is essentially identical to the previously applied discrete multitone signal, but with at least one carrier frequency being suppressed (missing tone method).

FIG. 5A shows, schematically, the spectrum of this discrete multitone signal.

The discrete carrier frequency fi is not applied to the modeling filter 18.

FIG. 5B shows the spectrum of the signal emitted from the modeling filter 18 to the measurement circuit 28. As can be seen from FIG. 5B, a spectral component which is produced by intermodulation is produced at the frequency f₁. The amplitude of the spectral component D is a measure of the nonlinearity of the adjusted modeling filter 18, and hence of the nonlinear signal distortion caused by the analog circuit 7.

The calculation circuit 32 uses the measured intermodulation product D to calculate the multitone power ratio MTPR as a measure of the nonlinearity of the analog test circuit 7, in accordance with the following equation:

$${MTPR}_{i} = 10 log ( \frac{{S}_{i}}{{N}_{i} + {\sum }_{f} {D}_{ij}} ) in dB \qquad ( 1 )$$

where the index i is the i-th carrier frequency,

Sᵢ is the transmitted signal power of the i-th carrier frequency,

N₁ is the noise, and

D₁ⱼ are the intermodulation products of the other j carrier frequencies in the DMT signal.

The stimulation signal u(t) produced by the signal generator 1 can be described as follows:

$$u ( t ) = {\sum }_{k = {n}_{1}}^{{n}_{2}} {A}_{k} cos ( k {ω}_{0} t + {ϕ}_{k} ) \qquad ( 2 )$$

where Aₖ is the amplitude and φₖ is the phase of the k-th carrier frequency. The DMT signals of different peak values, depending on the phase distribution. These peak values are defined by the crest factor.

The modeling filter 18 illustrated in FIG. 4 is, preferably, what is referred to as a Volterra filter. An Nth-order discrete Volterra filter with a memory length Mₙ is described by:

$$y ( 1 ) = {h}_{o} + {\sum }_{n = 1}^{N} {\sum }_{{k}_{1} = 0}^{{M}_{a} - 1} ⋯ {\sum }_{{K}_{2} = 0}^{{M}_{n} - 1} {h}_{n} ( {k}_{1} , … , {k}_{n} ) {\prod }_{i = 1}^{n} u ( 1 - {k}_{i} ) \qquad ( 3 )$$

where the Volterra cores hₙ(k₁, . . . , kₙ) represent the generalized impulse response of the digital filter components within the Volterra filter, and u₍₁₎ represents the input signal sequence.

In an alternative embodiment, the modeling filter 18 is a neural network. Such neural networks are described in S. Haykin “Neural Networks: A comprehensive foundation” in Prentice-Hall New York, 1998.

FIG. 6 shows, schematically, a Volterra filter as a modeling filter 18. Martin Schetzen describes the Volterra theory in “The Volterra and Wiener Theories of “Non linear System” John Wiley and Sons, New York 1980.

What is referred to as the Hammerstein model for Volterra filters is described by the following equation:

$${\overline{h}}_{nH} ( {k}_{1} , … , {k}_{n} ) = {h}_{n} ( {k}_{1} , … , {k}_{n} ) {\prod }_{i = 2}^{n} {δ}_{{k}_{1} , {k}_{2}} \qquad ( 4 )$$

The Hammerstein model is obtained from equations (3) and (4) as follows:

$$y ( 1 ) = {h}_{0} + {\sum }_{n = 1}^{N} {\sum }_{k = 0}^{{M}_{n} - 1} {{h}_{nH} ( k ) [ u ( 1 - k ) ]}^{n} \qquad ( 5 )$$

The Hammerstein model described by the equation (5) can be generalized as follows to form a Volterra-Hammerstein model:

$$y ( 1 ) = {h}_{0} + {\sum }_{n - 2}^{N} {\sum }_{{k}_{1} - 0}^{{\dot{M}}_{n} - 1} … {\sum }_{{k}_{1} = 0}^{{\dot{M}}_{n} - 1} {h}_{n} ( {k}_{1} , … , {k}_{n} ) {\prod }_{i = 1}^{n} u ( 1 - {k}_{i} ) + {\sum }_{n = 1}^{N} {\sum }_{k = {M}_{n}}^{{M}_{n} - 1} {{h}_{nH} ( k ) [ u ( 1 - k ) ]}^{n} \qquad ( 6 )$$

The equations (3), (5), (6) are linear in the parameters h, in which case the input signal sequence u(1) can be expressed as a vector:

u(1)=[u(1) . . . u(1−M₁)u(1)u(1−1) . . . u(1−M_{N})^{N}] (7)

and the corresponding parameter vector of the modeling filter 18 is given by:

h=[h₁(0) . . . h₁(M₁)h₂(0, 1) . . . h_{N}(M_{N}, . . . , M_{N})]^{T} (8)

The output signal sequence y(1) thus becomes:

y(1)=U(1)h (9)

where U (1):

U(1)=[u(1), . . . , u(1+S)]^{T} (10)

The Volterra cores h of the modeling filter 18 are thus adjusted by means of the adjustment circuit 15 until the difference signal at the output 12 of the subtraction circuit 11 is a minimum, that is to say the mean square error is a minimum.

By way of example, FIG. 7 shows the modeling of an analog SLIC circuit by means of three modeling filters 18-1, 18-2, 18-3. Together with further circuit components, for example a subtraction circuit 33, these form an overall equivalent circuit 34 for an SLIC circuit. By way of example, the adjusted modeling filter 18-1 is an equivalent circuit of the current sensor, the modeling filter 18-2 is an equivalent circuit of the echo compensation signal path, and the modeling filter 18-3 is an equivalent circuit of the transmission path of the SLIC circuit.

The modeling filters 18 have a filter order N. The filter order N is determined by applying a sinusoidal signal to the analog circuit 7 which is to be tested and [lacuna] is determined by Fast Fourier Transformation FFT of the output signal emitted from the analog circuit 7, for the number of harmonic frequencies. The number of harmonic frequencies determined in this way governs the filter order N of the modeling filters 18.

The modulation method according to the invention makes it possible to simulate nonlinearities in relatively complex analog circuit arrangements with high accuracy. It is thus possible to investigate the effects of nonlinear circuit elements within a complex overall system, which comprises analog and digital circuits. The use of Volterra mapping filters, particularly when using the Volterra-Hammerstein filter model, makes it possible to considerably reduce the number of model parameters to be adjusted and to be calculated. This makes it possible to carry out simulations of complex analog circuits with relatively little computation complexity. The required simulation times of the simulation method according to the invention are very short owing to the small number of model parameters required.

The simulation method according to the invention for the first time makes it possible to investigate nonlinear signal distortion in complex analog circuits which process discretely modulated tone signals.

### LIST OF REFERENCE SYMBOLS

1 Signal Generator

2 Output

3 Line

4 Branch Node

5 Line

6 Input

7 Analog Test Circuit

8 Output

9 Line

10 Input

11 Subtraction Circuit

12 Output

13 Line

14 Input

15 Adjustment Circuit

16 Output

17 Adjustment Lines

18 Modeling Filter

19 Input

20 Line

21 Output

22 Line

23 Branch Node

24 Line

25 Input

26 Line

27 Input

28 Measurement Circuit

29 Output

30 Line

31 Input

32 Calculation Circuit

33 Subtraction Circuit

34 Overall Circuit

1. A simulation method for determining nonlinear signal distortion in an analog circuit (7), which is to be tested, for processing discrete multitone signals (DMT), with the simulation method having the following steps:
(a) application of a discrete multitone signal, which has a large number of uniformly spaced carrier frequencies for data transmission in a predetermined frequency range, to the analog circuit (7), which is to be tested, and to a digital filter (18);
(b) suppression of the output signal from the analog circuit (7), which is to be tested, from the output signal from the digital filter (18) in order to produce a difference signal;
(c) adjustment of the digital filter (18) until the difference signal is a minimum, with the adjusted digital filter (18) forming an equivalent circuit of the analog circuit (7);
(d) application of the discrete multitone signal to the adjusted digital filter (18), with at least one carrier frequency being suppressed, for measuring the intermodulation product (D) of the adjusted digital filter (18).

2. The simulation method as claimed in claim 1, wherein
a multitone signal ratio is calculated from the measured intermodulation product.

3. The simulation method as claimed in claim 1 or 2, wherein
the adjustable modeling filter (18) is a discrete-time Volterra filter, or a neural network.

4. The simulation method as claimed in one of the preceding claims,
wherein
the adjustable modeling filter (18) is connected in parallel with the analog circuit (7) which is to be tested.

5. The simulation method as claimed in one of the preceding claims,
wherein
the adjusted modeling filter (18), which forms an equivalent circuit of an analog circuit (7), is connected to further adjusted modeling filters, which form equivalent circuits of further analog circuits, in order to generate an overall equivalent circuit for an analog overall circuit.

6. The simulation method as claimed in one of the preceding claims,
wherein
the analog overall circuit is a DSL-SLIC circuit.

7. The simulation method as claimed in one of the preceding claims,
wherein
the discrete multitone signals are generated in a signal generator (1).

8. A test arrangement for determining nonlinear signal distortion of analog circuit elements of a signal processing circuit for signal processing of DMT signals having:
(a) a signal generator (1) for producing a discrete multitone signal;
(b) adjustable modeling filters (18) which are each connected in parallel with an associated analog circuit element (7), with the signal inputs of the modeling filters (18) and of the analog circuit elements (7) being connected to the signal generator (1);
(c) subtraction circuits, which each subtract the output signal from a modeling filter (18) from the output signal from the associated analog circuit element (7) in order to form a difference signal;
(d) an adjustment circuit, which compares the difference signals with a nominal value and adjusts the modeling filters (18) until the difference signals match the nominal value; and having
(e) a measurement circuit, which is connected to the outputs of the modeling filters (18), for measuring the intermodulation products of the adjusted modeling filters (18).

9. The test arrangement as claimed in claim 8,
wherein
the test circuit is followed by a calculation circuit (32) for calculating the multitone signal power ratio of the output signals which are emitted from the modeling filter (18).
